(19) United States
(12) Patent Application Publication
(10) Pub. No.: US 2007/0280043 A1
(43) Pub. Date: Dec. 6, 2007

(54) Device for holding mixing container during use

(76) Inventor: Antonio Cintorino, Henrietta, NY (US)

Correspondence Address: JAMES RAY & ASSOCIATES, 2640 PITCAIRN ROAD, MONROEVILLE, PA, 15146, US

(21) Appl. No.: 11/804,880

(22) Filed: May 21, 2007

Related U.S. Application Data
(60) Provisional application No. 60/808,353, filed on May 25, 2006.

(51) Int. Cl. B01F 15/00

(52) U.S. Cl. 366/215; 366/129; 366/349

(57) ABSTRACT

A device for releaseably securing a mixing container includes a rectangular frame and a first member which is secured to one end of the frame and which has a V-notch formed therein for contacting a first portion of the base of the container. A second member is positioned adjacent an opposed end of the frame and has a complimentary V-notch for contacting a second portion of the base of the container which is disposed radially opposite from the first wall portion. A hinge is provided for pivotally attaching the second member to the frame and enabling the second member to be pivotally moved between a first operative position wherein the container is contacted by and frictionally caged intermediate the first V-notch and the second V-notch and a second position wherein the container is releasable from contact with the both V-notches.

### CROSS-REFERENCE TO RELATED APPLICATIONS

This application is related to and claims priority from Provisional Patent Application Ser. No. 60/808,353 filed May 25, 2006.

### FIELD OF THE INVENTION

The present invention relates, in general, to container holding devices and, more particularly, this invention relates to a manually operated device for securely holding a container suitable for mixing slurry material in a stationary position and preventing it from rotating during mixing operation.

### BACKGROUND OF THE INVENTION

As is generally well known, users of mixing containers, such as 2.5 or 5.0 gallon buckets, which are extensively used in various construction trades experience difficulties in securing the container in stationary position so as to prevent its spinning during mixing operation. Commonly, the user will secure such container with his or her legs or feet and bend over to use the mixing implement, such as power stirrer, thus exposing the lower back to undesirable strains and muscle aches. Similar technique is used for removing the lid or separating containers vertically stacked into each other. It is also common for the user to place one foot onto the rim of the container. However, in this position, the user is susceptible to groin injuries when using the power stirrer. Furthermore, the bucket may easily tip onto its side spilling the contents thereof or the power stirrer can catch onto loose clothing and cause damage thereto.

Prior to the present invention, efforts have been made to alleviate the aforedescribed problems. U.S. Pat. No. 6,361,001 issued to Durand discloses one type of a container holder which is formed from a one-piece raised top portion having a centrally disposed aperture allowing insertion of a stirring paddle. Descending from the top portion are two legs that extend downwardly and span the entire height of the bucket to be mixed with foot pads joined at the bottom of the legs extending outwardly therefrom which allow an individual to stand on during the mixing operation. In operation, an individual places the instant invention over the rim of the bucket and adjusts the foot pads to be flush with the support surface. The legs are sized so as to cause engagement of the rim by the top portion when the foot pads are stepped on. However, such container holder has a more complex than desirable construction due to the need for adjusting the foot pads in order to accommodate 2.5 and 5.0 buckets which have identical base but varying heights and further requires the user to form notches in the bucket rim with a knife or snips in order to insert engagement tabs which are located along a lower surface of the top portion of the container holder. Furthermore, the bucket is held away from its base during mixing operation and, more particularly, it is held away from its portion where the highest centrifugal force is generated during mixing operation when using power stirrer. Additionally, this prior art container holder requires greater than desirable storage space.

U.S. Pat. No 6,779,915 issued to Foster, Jr. discloses another type of the container holder which is formed as a substantially rectangular box structure having a top, a bottom and four sides made perpendicular to the bottom and top surfaces. The top surface portion is raised above the ground and has disposed therein a substantially central circular aperture for frictionally retaining a bucket containing material to be mixed therein. In operation the user mounts the platform and inserts a bucket with mixing material within the aperture for subsequent manual or motor-tool driven mixing. While having a simpler construction than the bucket holder of Durand, this bucket holder cannot support the bucket at its base and also requires greater than desirable storage space. Furthermore, the raised top surface portion requires the user to be elevated above the working surface which is detrimental to user's safety.

Therefore, there is a need for an improved device for securing the mixing container in a stationary position and preventing it from rotating during use.

### SUMMARY OF THE INVENTION

The present invention provides a device for releaseably securing a mixing container in a fixed and upright position and for preventing it from rotating during use. The container is characterized by a base and a continuous wall extending outwardly from the base and forming a rim. The device includes a frame which has each of a predetermined shape and a predetermined size. A first holding means is secured to the frame or being integral therewith for contacting a first portion of the base. A second holding means is provided for contacting a second portion of the base which is disposed radially opposite from the first wall portion. A pivot means is provided for pivotally attaching the second holding means to the frame. The pivot means enables the second holding means to be pivotally moved between a first operative position wherein the container is contacted by and frictionally caged intermediate the first holding means and the second holding means and a second position wherein the container is releasable from contact with the first holding means and the second holding means. An optional foot pad is provided intermediate the frame and the second holding means to facilitate use of the device, whereby the second holding means is pivotally coupled to the foot pad.

### OBJECTS OF THE INVENTION

It is, therefore, one of the primary objects of the present invention to provide a device for securely holding a mixing container in a stationary position.

Another object of the present invention is to provide a device for securely holding a mixing container which prevents the container from rotating during mixing operation.

Yet another object of the present invention is to provide a device for securely holding a mixing container which frictionally engages the base of the mixing container.

A further object of the present invention is to provide a device for securely holding a mixing container which does not elevate user above the working surface.

Yet a further object of the present invention is to provide a device for securely holding a mixing container which can be conveniently stored.

An additional object of the present invention is to provide a device for securely holding a mixing container which is economical to manufacture.

Another object of the present invention is to provide a device for securely holding a mixing container which is simple to use.

A further object of the present invention is to provide a device for securely holding mixing containers of various heights.

Another object of the present invention is to provide a device for securely holding mixing containers of various diameters.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a planar view of the device of the present invention for holding mixing container during use thereof;

FIG. 2 is an elevation view of the device of FIG. 1, particularly illustrating its use with a mixing container of a well known bucket type having a round base;

FIG. 3 is a partial cross-sectional view of the device of FIG. 1, particularly illustrating hinge arrangement constructed according to one embodiment of the invention; and

FIG. 4 is a partial cross-sectional view of the device of FIG. 1, particularly illustrating hinge arrangement constructed according to another embodiment of the invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

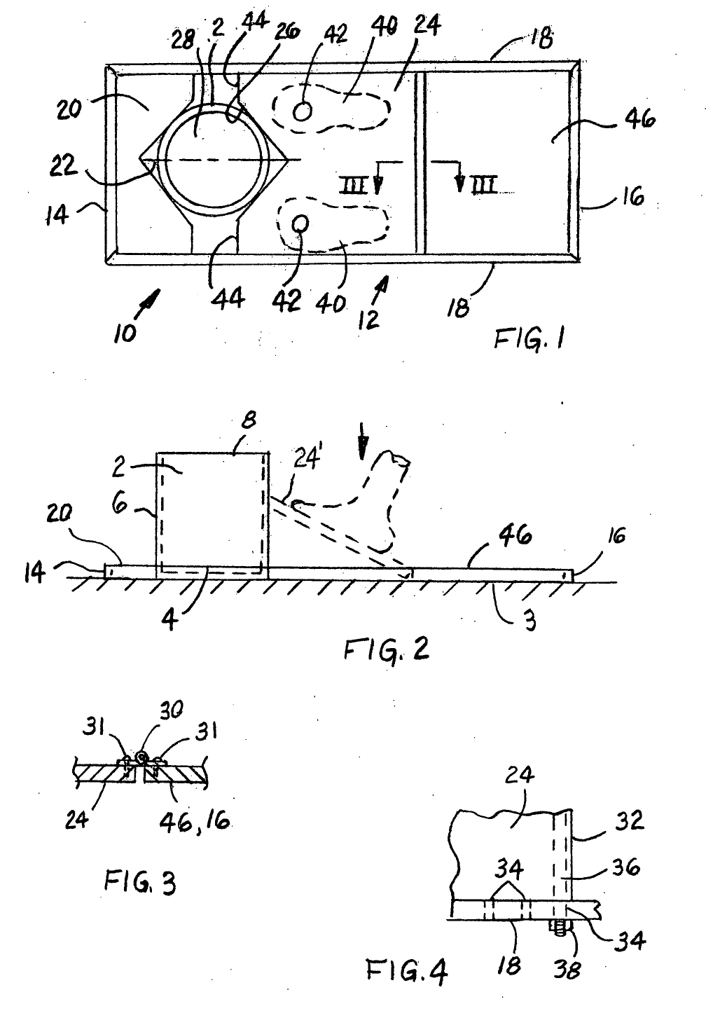

Reference is now made, to FIGS. 1-4, wherein there is shown a device, generally designated as 10, for releaseably securing a container 2 in a fixed position and upright position and for preventing it from rotation during use. The container 2, illustrated in FIG. 2, is generally well known as a “bucket” which is characterized by a circular base 4 and a continuous wall 6 extending outwardly from the base 4 and forming a rim 8. Depending on a particular construction, the continuous wall 6 may be tapered upwardly forming the rim 8 which is larger than the base 4. However, it is within the scope of the present invention to use the device 10 with various shapes and sizes of the base 4.

The device 10 includes a frame, generally designated as 12, having each of a predetermined shape and a predetermined size. In the presently preferred embodiment of the invention, the frame 12 has a rectangular shape and is formed by a first elongated end member 14, a second elongated end member 16 and a pair of elongated side members 18 each connecting opposed and aligned ends of the first elongated member 14 and the second elongated member 16. The frame 12 can be manufactured from a material selected from wood, plastic, metal and any combinations thereof. It is presently preferred for the frame 12 to be manufactured from a lightweight metal such as aluminum. It has been found advantageous to form each elongated member 14, 16 or 18 either from a tubular or U-shaped material to provide adequate rigidity during use while minimizing the weight of the frame 12. The presently preferred height of the frame 12 is about 0.75 inches. Alternatively, the frame 12 may be manufactured as a unitary construction from a plastic material by a molding method.

There is a first holding means which includes a first plate-like holding member 20 being stationary secured to the frame 12 or formed integral therewith and a notch 22 formed within the first holding member 20. The notch 22 receives therein and contacts a first portion of the base 4 of the container 2. It is presently preferred for the notch 22 to have a V-shape thus contacting the first portion of the base 4 at two points disposed thereon, although the present invention contemplates that other shapes of the notch 22 suitable for receiving therein and contacting the first portion of the base 4 can be employed in the present invention. For example, the notch 22 may have a half round shape further augmented by a plurality of serrations for facilitating frictional engagement with the first portion of the circular base 4.

There is a second holding means which includes a second plate-like holding member 24 and a notch 26 formed therewithin. The notch 26 receives therein and contacts a second portion of the base 4 of the container 2 which is disposed radially opposite from the first base portion. It is presently preferred for the notch 26 to be formed identical to the notch 22.

When the frame 12 has a rectangular shape, the first plate-like holding member 20 is positioned adjacent one of end members 14, 16 and the second plate-like holding member 22 is positioned adjacent the opposed one of end members 14, 16.

A pivot means is provided for pivotally coupling the second holding member 24 to the frame 12 and for enabling the second holding member 24 to be pivotally moved between a first operative position wherein the container 2 is contacted by and frictionally caged intermediate the V-notches 22 and 26 and a second position wherein the container 2 is releasable from contact with the V-notches 22 and 26. In such first position, the second holding member 24 is disposed generally coplanar to the frame 12. Accordingly, the pair of V-notches 22 and 26 form an aperture 28 which is sized smaller than the rim 8 and which is sized smaller than the base 4 of the container 2 enabling the V-notches 22 and 26 to frictionally engage the base 4.

Such pivot means may include a well known continuous hinge arrangement 30 which is secured to the first holding member 24 and the second end 16, as best shown in FIG. 3. Alternatively, as shown in FIG. 4, the pivot means may include an aperture 32 formed within distal end of the second holding member 24, a pair of apertures 34 each formed within a respective side member 18 and aligned with the aperture 32 and a shaft 36 which is inserted through apertures 32 and 34 and which is retained from axially disengaging the apertures 32 and 34. For example, the ends of the shaft 36 may be threaded and a threaded fastener 38 may be threadeably secured to each threaded end. Only one side member 18, aperture 34 and threaded fastener 28 are shown in FIG. 4, as the retention of the shaft 36 at the other side member 18 will be identical. It will be understood that the use of the pivoting arrangement of FIG. 4 is advantageous to accommodate various sizes of the base 4 by providing a plurality of apertures 34 formed within each side member 18 in a spaced and aligned relationship to each other in order to adjustably accommodate shaft 36. Thus, by selecting one set of apertures 34 which is related to the size of the base 4, the second holding member 24 may be moved toward to or away from the first holding member 22 thus adjusting the size of the aperture 28 in order to accommodate a particular size of the base 4. Therefore, the use of pivoting arrangement of FIG. 4, including plurality of spaced apart apertures 34, enables the device 10 to accommodate various sizes of the base 4 beyond the commonly used 2.5 or 5.0 gallon bucket type containers. It will be appreciated that the notches 22 and 26 will be sized and shaped to also accommodate various sizes and shapes of the base 4.

It will be understood that when the second holding member 24 is coupled to the foot pad 46 with the hinge 30, it may be advantageous for adjustably positioning both the second holding member 24 and the foot pad 46, in which case an open space may be formed between a distal end of the foot pad 46 and the second end member 16 of the frame 12. The present invention further contemplates that any other well known pivot means, for example such as a spring loaded pins (not shown) engaging apertures 34, may be utilized in the present invention for pivotally moving the second holding member 24 between the first and second positions as well as for enabling adjustable positioning of such second holding member 24 in order to accommodate various sizes of the base 4.

In use, the device 10 is positioned above the container 2 in order to align the pair of V-notches 22 and 26 with the top rim 8. The device 10 is then moved downwardly toward the working surface 3 that the container 2 is standing on and is positioned in abutting relationship with such working surface 3, as best shown in FIG. 2. During downward movement of the device 10, the second holding member 24 pivots away from the base 4 and is disposed intermediate the first and second positions, as referenced by numeral 24′ in FIG. 2, in order to place the device 10 into the abutting relationship with the working surface 3. The user of the device 10 then applies force to the second holding member 24 in order to move it into the first position frictionally engaging the V-notch 26 with the portion of the base 4 and caging the base 4 of the container 2 against the V-notch 22. For example, the user can simply step onto the second holding member 24 and apply sufficient force as such force does not exceed 100 pounds thus enabling any user in the construction trade to use the device 10. Accordingly, a pair of foot print outlines 40 are disposed on the top surface of the second holding member 24 for directing the user to an optimum position of his or her feet. The foot print outlines 40 may be simply painted onto the second holding member 24, provided as a decal having an adhesive backing or indented into the second holding member 24. After the base 4 is caged, the user can then attend to matters of using the container 2 either to open the lid (not shown), mix slurry material contained therein or to simply disengage stacked containers 2. Advantageously, the device 10 can be used with containers 2 having varying heights of the continuous wall 6.

When the user needs to remove the container 2 from the device 10, the user simply applies force to the device 10 in the downward direction and lifts the container 2 pivoting the second holding member 24 upwardly during the lifting process. Or, the second holding member 24 may be provided with at least one and preferably a pair of apertures 42 formed therein for enabling the user of the device 10 to insert a finger through the at least one aperture 42 for manually pivoting the second holding member 24 between the first and the second position. The bottom edge of the at least one aperture 42 is beveled for the convenience of the user. Alternatively or in combination with the at least one aperture 42, the finger grip portions 44 may be formed within the second holding member 24.

To facilitate removal of the container 2, the present invention provides a foot pad 46 which is stationary secured to or formed integral with the frame 12 at the end thereof which is disposed opposite the end having the first holding member positioned thereabout and wherein the second holding member 24 is pivotally attached to the distal end thereof. The user than simply stands on top of the foot pad 46 thus preventing movement of the device 10 while disengaging the container 2 from contacts with notches 22 and 26 and removing the container 2 from the device 10. It has been found advantageous for the rectangular frame 12 to be about 17 inches in width and about 36 inches in length when the device 10 includes the foot pad 46.

It will be apparent to those skilled in the art that rather than removing the container 2 from the device 10, the device 10 can be disengaged from the container 2 and lifted over such container 2. To achieve this, the user simply stands on the foot pad 46 and uses the at least one aperture 42 or the finger grip portions 44 to pivotally move the second holding member 24 towards the second position.

As it has been stated above, the frame 12 can be manufactured from any material. It is presently preferred to manufacture the first holding member 20, the second holding member 24 and the optional foot pad 46 from a material which prevents forming of at least one of a rust and a mildew. A plastic material, and more particularly an engineered polymer, such as polyethylene, can be employed in the present invention to prevent forming of rust or mildew as well as to provide the required rigidity during use.

When the frame 12 is formed from the same engineered polymer material as the first holding member 20, the second holding member 24 and the optional foot pad 46, it is advantageous to form the first holding member 20 and the foot pad 46 integral with the frame 12 by a molding method thus providing for economical manufacture of the device 10.

It will be appreciated that securing the container 2 at its base 4, enables use of the device 10 with containers of various heights without the need for adjustment. Furthermore, an advantageously low height of the device 10 does not present safety concerns associated with prior art holding devices. Furthermore, the planar construction of the device 10 enables ease of storage without the need for any additional manipulation effort associated with prior art holding devices.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim

1. A device for releaseably securing a container in a fixed and upright position and for preventing it from rotating during use, the container being characterized by a base and a continuous wall extending outwardly from the base and forming a rim, said device comprising:
(a) a frame having each of a predetermined shape and a predetermined size;
(b) a first holding means which is secured to said frame or formed integral therewith for contacting a first portion of the base of the container;
(c) a second holding means which is positioned in a spaced relationship with said first holding means for contacting a second portion of the base of the container; and
(d) a pivot means for pivotally attaching said second holding means to said frame and enabling said second holding means to be pivotally moved between a first operative position wherein the container is contacted by and frictionally caged intermediate said first holding means and said second holding means and a second position wherein the container is releasable from contact with said first holding means and said second holding means.

2. The device, according to claim 1, wherein said frame includes a rectangular shape formed by a first elongated end member, a second elongated end member and a pair of elongated side members each connecting opposed and aligned ends of said first elongated end member and said second elongated end member.

3. The device, according to claim 1, wherein said frame is manufactured from a material selected from wood, plastic, metal and any combinations thereof.

4. The device, according to claim 3, wherein said frame is formed as a unitary construction from said plastic material by a molding process.

5. The device, according to claim 1, wherein said first holding means is stationary secured to said frame.

6. The device, according to claim 1, wherein said first holding means includes a notch for receiving therein and for contacting the first portion of the base of the container.

7. The device, according to claim 1, wherein said second holding means includes a notch formed therein for receiving therein and for contacting the second portion of the base of the container.

8. The device, according to claim 7, wherein said second holding means includes at least one aperture formed therein enabling the user of said device to insert a finger through said at least one aperture for manually pivoting said second holding means between said first and said second position.

9. The device, according to claim 7, wherein said second holding means includes a plate like member which is disposed generally coplanar to said frame in said first position and wherein said plate like member includes said notch.

10. The device, according to claim 7, wherein said notch has a V-shape.

11. The device, according to claim 1, wherein said pivot means includes a continuous hinge arrangement.

12. The device, according to claim 1, wherein said pivot means includes a first aperture formed within said second holding means, a pair of second apertures each formed within a respective side member and axially aligned with said first aperture formed within said second holding means, a shaft which is inserted through said first and second apertures and means for retaining said shaft within said device and for preventing said shaft from axially disengaging said side members of said frame.

13. The device, according to claim 12, wherein said device includes a plurality of said second apertures formed in a spaced and aligned relationship within each of said pair of side members for adjusting said spaced relationship of said first holding means and said second holding means for accommodating containers having varying base sizes.

14. The device, according to claim 1, wherein said device further includes a foot pad which is secured to said frame for facilitating release of the container from frictional engagement with said first holding means and said second holding means.

15. The device, according to claim 1, wherein said device is formed from a material which prevents forming of at least one of a rust and a mildew.

16. The device, according to claim 1, wherein said device further includes means for adjusting said spaced relationship of said first holding means and said second holding means for accommodating containers having varying base sizes.

17. A device for releaseably securing a container in a fixed and upright position and for preventing it from rotating during use, the container being characterized by a circular base and a continuous wall extending outwardly from the base and forming a rim, said device comprising:
(a) a rectangular frame formed by a first elongated end member, a second elongated end member and a pair of elongated side members each connecting opposed and aligned ends of said first elongated end member and said second elongated end member;
(b) a first holding member which is secured to or formed integral with said frame adjacent said first elongated end member;
(c) a first V-notch formed in said first holding member for contacting a first portion of the base of the container;
(d) a foot pad which is secured to or formed integral with said frame adjacent said second elongated end member;
(e) a second holding member which is positioned in a spaced relationship with said first holding member;
(f) a second V-notch formed in said second holding member and aligned with said first V-notch formed in said first holding member for contacting a second portion of the continuous wall of the container; and
(g) a pivot means for pivotally attaching said second holding member to said foot pad and enabling said second holding member to be pivotally moved between a first operative position wherein the container is contacted by and frictionally caged intermediate said first V-notch and said second V-notch and a second position wherein the container is releasable from contact with said first V-notch and said second V-notch.

18. The device, according to claim 17, wherein said first holding member and said foot pad are formed integral with said frame.
